(19) United States
(12) Patent Application Publication
(10) Pub. No.: US 2023/0187699 A1
(43) Pub. Date: Jun. 15, 2023

(54) METHOD OF MAKING SOLID STATE ELECTRODE AND ELECTROLYTE FOR ALL SOLID STATE LITHIUM BATTERIES BY LAYERING

(71) Applicant: HYZON MOTORS INC., Honeoye Falls, NY (US)

(72) Inventors: Rajesh Bashyam, Delta (CA); Zhijun Gu, Naperville, IL (US); Sai Nitin Yellamilli, Naperville, IL (US)

(21) Appl. No.: 18/080,717

(22) Filed: Dec. 13, 2022

Related U.S. Application Data
(60) Provisional application No. 63/289,229, filed on Dec. 14, 2021.

(51) Int. Cl. H01M 10/0568; H01M 4/505; H01M 10/0562; H01M 10/0525; H01M 4/62; H01M 4/525

(52) U.S. Cl. CPC H01M 10/0568; H01M 4/505; H01M 10/0562; H01M 10/0525; H01M 4/625; H01M 4/525; H01M 2300/0025; H01M 2004/021

(57) ABSTRACT

Methods of making a solid state electrode and electrolyte for an all solid state lithium battery include mixing a lithiated perfluorosulfonic acid with a solvent to form an electrolyte polymer solution, mixing lithiated perfluorosulfonic with garnet type oxide polymer-composite solution, preparing a cathode electrode, coating the cathode electrode with the electrolyte polymer solution to form an electrolyte layer, laminating a reinforcement layer over the electrolyte polymer solution coated onto the cathode electrode, and coating the reinforcement layer with electrolyte polymer solution to form another electrolyte layer to form the solid state electrode and electrolyte.

### CROSS-REFERENCE TO RELATED APPLICATIONS

This application claims the benefit of U.S. Provisional Application No. 63/289,229, filed on Dec. 14, 2021. The entire disclosure of the above application is hereby incorporated herein by reference.

### FIELD

The present technology includes processes and articles of manufacture that relate to solid-state lithium-ion batteries and solid-state batteries, including a process of making electrodes and electrolytes for all solid-state batteries.

### INTRODUCTION

This section provides background information related to the present disclosure which is not necessarily prior art.

All solid-state batteries are gaining significant attention in lithium-ion battery development due to several advantages, including consistent operation, high energy density, and faster charging properties. However, certain challenges remain to be overcome, especially with respect to solid-state electrolytes, in order to improve conductivity and suppress formation of lithium dendrites. Two main approaches are being employed to develop solid electrolytes, the first being the use inorganic ceramic solid electrolytes and the second being use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. Certain types and applications of batteries can require dimensions and configurations that can be difficult to process, handle, and manipulate during manufacture, which can also present issues during use of the assembled battery. Batteries can be subjected to environments that can experience particular shocks related to physical forces as well as varying temperatures, where it may be optimal to design a battery that can provide a predetermined performance throughout a wide range of operating conditions. Durability and stability of electrode and electrolyte components of the battery are hence important considerations in manufacture and performance of the assembled battery.

Accordingly, there is a need for an electrode-electrolyte composite having improved durability and stability for solid-state lithium-ion battery applications. The electrode-electrolyte composite should optimize cathode electrode design and processing, provide improved performance with respect to speed and scale of battery manufacture, and increase operational integrity of the battery.

### SUMMARY

In concordance with the instant disclosure, ways to maximize durability and stability of all solid-state lithium-ion batteries that further address challenges associated with cathode electrode design and processing, are surprisingly discovered.

In certain embodiments, methods of making a solid-state electrode and electrolyte are provided. These methods include forming an electrode layer using an electrode composition, where the electrode composition includes a cathode active material, a lithiated ionomer, and an electrically conductive additive. An electrolyte composition is applied directly to the electrode layer to form a first electrolyte layer, where the electrolyte composition includes a lithiated perfluorosulfonic acid and a first solvent. A reinforcement layer is applied to the first electrolyte layer and the electrolyte composition is applied to the reinforcement layer to form a second electrolyte layer. In this way, the electrode layer, the first electrolyte layer, the reinforcement layer, and the second electrolyte layer form an electrode-electrolyte composite. The electrode-electrolyte composite can exhibit improved durability and stability during manufacture and operation of a solid-state lithium-ion battery employing the composite.

In certain embodiments, methods of making a solid state electrode and electrolyte for an all solid state lithium battery include mixing a lithiated perfluorosulfonic acid with a solvent to form an electrolyte polymer solution, preparing a cathode electrode, coating the cathode electrode with the electrolyte polymer solution, laminating a reinforcement layer over the electrolyte polymer solution coated onto the cathode electrode and coating the reinforcement layer with an additional polymer layer to form the solid state electrode and electrolyte.

Various solid-state electrode and electrolytes can be made according to the present technology. Such electrode-electrolyte composites can be incorporated into all solid-state lithium-ion batteries. Likewise, various batteries, including multicell batteries, can be manufactured using one or more of the electrode-electrolyte composites. Certain applications include vehicles using a solid-state lithium ion battery that incorporates one or more electrode-electrolyte composites made in accordance with the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic flowchart of a method of making a solid-state electrode and electrolyte for a solid-state lithium-ion battery by layering, in accordance with the present technology; and

FIG. 2 is a schematic cross-sectional design of an embodiment of a solid-state electrode and electrolyte for a solid-state lithium-ion battery, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to ways of making and using a solid-state electrode and electrolyte for a solid-state lithium-ion battery that include a reinforcement layer within electrolyte layers. Methods and articles formed using the subject methods result in a solid-state electrode and electrolyte providing an electrode-electrolyte composite having improved durability and stability for solid-state lithium-ion battery applications. The electrode-electrolyte composite further optimizes cathode electrode design and processing, including improved performance with respect to speed and scale of battery manufacture.

A method of making a solid-state electrode and electrolyte is provided that includes forming an electrode layer using an electrode composition, where the electrode composition includes a cathode active material, a lithiated ionomer, and an electrically conductive additive. An electrolyte composition is applied directly to the electrode layer to form a first electrolyte layer, where the electrolyte composition includes a lithiated perfluorosulfonic acid and a first solvent. A reinforcement layer is applied to the first electrolyte layer, followed by application of the electrolyte composition to the reinforcement layer to form a second electrolyte layer. The electrode layer, the first electrolyte layer, the reinforcement layer, and the second electrolyte layer form an electrode-electrolyte composite.

The cathode active material can include the following aspects. The cathode active material can include a metal oxide and/or a metal phosphate. The metal oxide can include one or more of cobalt oxide, iron oxide, manganese oxide, and nickel oxide. The metal phosphate can include one or more of cobalt phosphate, iron phosphate, manganese phosphate, and nickel phosphate.

The lithiated ionomer can include the following aspects. The lithiated ionomer can include a lithiated compound, where the lithiated compound can include one or more lithiated perfluorosulfonic acids. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The electrically conductive additive can include the following aspects. Examples of the electrically conductive additive include carbon, carbon microfibers, carbon nanofibers, carbon nanotubes, graphite nanofibers, and graphene. Mixtures of various electrically conductive additives can be used. In certain embodiments, the electrically conductive additive can include Super P™, a structured carbon black powder with a moderate surface area, available from Imerys S.A. (Paris, France).

The electrode composition can include the following aspects. The electrode composition can have a ratio of (the cathode active material):(the lithiated ionomer):(the electrically conductive additive) of (60-85):(10-20):(5-20). Certain embodiments include where the ratio of (the cathode active material):(the lithiated ionomer):(the electrically conductive additive) includes 60:20:20, 70:10:20, 70:20:10, 80:10:10, and 85:10:5. The electrode composition can be processed to form a predetermined particle size prior to forming the electrode layer using the electrode composition. Embodiments include where the predetermined particle size can be from 10 nanometers to less than 1 micrometer. Various processes can be employed to form the predetermined particle size, including use of a high shear rotary mixer, a ball mill, various overhead mixers, high pressure mixers, planetary ball mixers, and the like.

The lithiated perfluorosulfonic acid of the electrolyte composition can include the following aspects. The lithiated perfluorosulfonic acid can have an equivalent weight (EW) of 300 to 1100. The lithiated perfluorosulfonic acid can include one or more of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The solvent of the electrolyte composition can include the following aspects. The solvent can include one or more various organic solvents, including various alcohols, as well as various aprotic solvents, including various amines and cyclic amines. Particular examples of solvents include methanol, ethanol, n-propanol, isopropanol, N-methyl-2-pyrrolidone (NMP), and/or water.

In certain embodiments, the electrolyte composition used to form the electrolyte layers can include a ceramic oxide. The ceramic oxide can include various garnet type oxides. Particular examples of the ceramic oxide include one or more of lithium lanthanum zirconium oxide (LLZO), metal (M) doped lithium lanthanum zirconium oxide (LLZMO), lithium lanthanum titanium oxide (LLTO), metal (M) doped lithium lanthanum titanium oxide (LLTMO), and combinations thereof, where the metal (M) can be one or more of aluminum, niobium, and tantalum.

The electrolyte composition can be processed to form a predetermined particle size prior to applying the electrolyte composition directly to the electrode layer to form the first electrolyte layer. For example, where the electrolyte composition used to form the electrolyte layers includes a ceramic oxide, the electrolyte composition can be processed so that the ceramic oxide, as well as any other components of the electrolyte composition have a predetermined particle size. The particle size can include a window or range of particle sizes having a lower limit and an upper limit. The particle size can also include where a majority of the particles have a predetermined particle size. Examples include where the predetermined particle size is from 10 nanometers to less than 1 micrometer.

Applying the electrolyte composition directly to the electrode layer to form the first electrolyte layer can include the following aspects. Various apparatus and techniques can be selected based upon the nature of the electrode layer, considering dimensions as well as workflow. The nature of the desired first electrolyte layer can also be considered in applying the electrolyte composition. Application methodologies can include using a doctor blade, a micro gravure roller, as well as a slot die, for example. The first electrolyte layer can be formed by applying the electrolyte composition directly to the electrode layer to provide various thicknesses, where certain embodiments include a thickness from 2 micrometers to 30 micrometers.

The reinforcement layer and application thereof can include the following aspects. Applying the reinforcement layer to the first electrolyte layer can include laminating the reinforcement layer to the first electrolyte layer. Laminating can include the application of heat and/or pressure. Laminating can further improve direct contact between the electrode and the electrolyte interface. The reinforcement layer can include various polymers, including various porous polymers. Examples include fluoropolymers, such as polytetrafluoroethylene (PTFE), as well as expanded polytetrafluoroethylene (ePTFE). Other polymers include polysaccharides, such as cellulose, as well as porous cellulose membranes. The reinforcement layer can impart structural durability and stability to the resulting electrode-electrolyte composite and solid-state lithium-ion batteries incorporating such. This can include resistance to tearing, puncture, dimensional changes based upon environmental conditions (e.g., temperature), and the like, thereby optimizing integrity of a solid-state lithium-ion battery based thereon. The improved direct interface between the electrode and the electrolyte can also provide uniformity across the interface and allow the battery to perform in a more consistent manner.

The electrode-electrolyte composite formed by the present technology can be subject to further processing steps. In certain embodiments, the electrode-electrolyte composite can be swelled using a solvent. For example, the electrode-electrolyte composite can be soaked within or placed in contact with the solvent. The solvent can include the same solvent or solvent blend present in the electrolyte composition used to form the electrolyte layers, or the solvent can include a different solvent or solvent blend. Examples of the solvent used to well the electrode-electrolyte composite include various alkylene carbonates, where particular embodiments include ethylene carbonate and/or propylene carbonate. In certain embodiments, an anode layer can be disposed adjacent the second electrolyte layer of the electrode-electrolyte composite, where the anode layer includes a first metal layer. The first metal layer can include lithium. The anode layer can further include a second metal layer. For example, the first metal layer can include lithium and can be disposed adjacent the second electrolyte layer, while the second metal layer can include copper and can be disposed adjacent the first metal layer and opposite the second electrolyte layer. Examples include where the anode layer is lithium coated copper.

Various articles of manufacture can be produced in accordance with the present technology. The solid-state electrode and electrolyte made according to the present methods can be provided, including the resulting electrode-electrolyte composite. Various solid-state lithium-ion batteries can incorporate the solid-state electrode and electrolyte made according to the present methods. Likewise, various articles and systems employing solid-state lithium-ion batteries can use the present technology. A particular example includes a vehicle that includes a solid-state lithium-ion battery incorporating the solid-state electrode and electrolyte made as described herein.

The present technology can provide certain benefits and advantages in lithium-ion solid-state batteries, including batteries used for various portable and mobility applications such as vehicles. Several issues with respect to lithium-ion batteries are addressed by the present technology, including increasing the lithium-ion transport and conductivity in the electrode and addressing challenges associated with cathode electrode design and processing. In particular, the present technology can increase the lithium-ion transport and conductivity through a novel way of making the reinforced Li-PFSA based electrolyte and a Li-PFSA ceramic composite electrolyte. The electrode-electrolyte composite further optimizes cathode electrode design and processing, increasing durability and stability of the electrode-electrolyte composite, permitting improved handling, and increasing speed and scale of battery manufacture.

### Examples

Example embodiments of the present technology are provided with reference to the figures enclosed herewith.

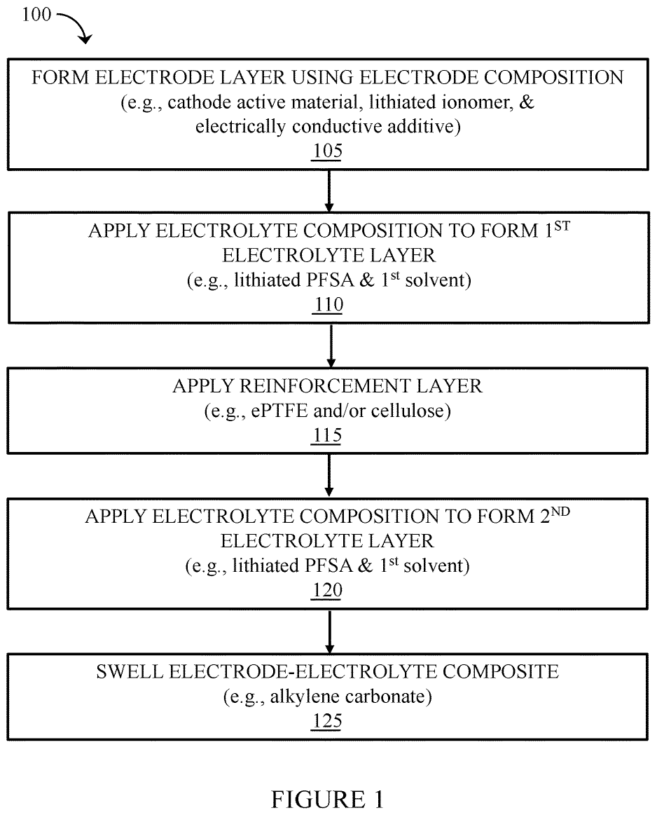

With reference to FIG. 1, an embodiment of a method of making a solid-state electrode and electrolyte for a solid-state lithium-ion battery by layering is shown at 100. At 105, an electrode layer can be formed using an electrode composition, where the electrode composition can include a cathode active material, a lithiated ionomer, and an electrically conductive additive. At 110, an electrolyte composition can be directly applied to the electrode layer to form a first electrolyte layer, where the electrolyte composition can include a lithiated perfluorosulfonic acid and a first solvent. The electrolyte composition can further include a ceramic oxide (e.g., garnet type oxide) and the electrolyte composition can be processed to form a predetermined particle size. At 115, a reinforcement layer can be applied to the first electrolyte layer. At 120, the electrolyte composition can be applied to the reinforcement layer to form a second electrolyte layer, where the electrode layer, the first electrolyte layer, the reinforcement layer, and the second electrolyte layer can form an electrode-electrolyte composite. Applying the reinforcement layer to the first electrolyte layer can include laminating the reinforcement layer to the first electrolyte layer, optionally including the use of pressure and/or heat. At 125, it is possible to swell the electrode-electrolyte composite using a second solvent; e.g., including one or more alkylene carbonates. The electrode-electrolyte composite can then be used in the manufacture of one or more lithium-ion battery cells.

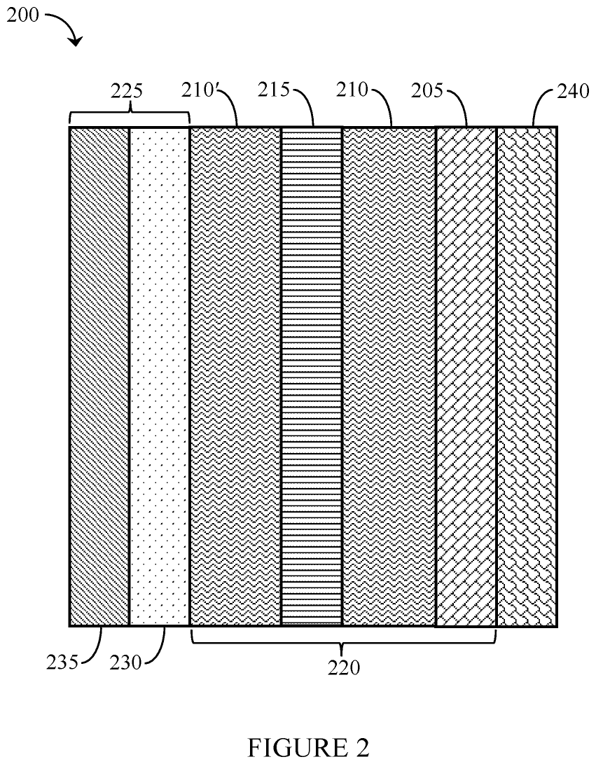

With reference to FIG. 2, a schematic cross-sectional design of an embodiment of a solid-state electrode and electrolyte for a solid-state lithium-ion battery is shown at 200. An electrode layer 205 is formed from an electrode composition including a cathode active material, a lithiated ionomer, and an electrically conductive additive. A first electrolyte layer 210 is formed by applying an electrolyte composition directly to the electrode layer 205, where the electrolyte composition includes a lithiated perfluorosulfonic acid and a first solvent. The electrolyte composition can optionally include a ceramic oxide (e.g., garnet type oxide) and can optionally be processed to form a predetermined particle size. A reinforcement layer 215 is applied to the first electrolyte layer 210. A second electrolyte layer 210′ is formed by applying the electrolyte composition to the reinforcement layer. The electrode layer 205, the first electrolyte layer 210, the reinforcement layer 215, and the second electrolyte layer 210′ form an electrode-electrolyte composite 220. It is possible to swell the electrode-electrolyte composite 220 using a second solvent; e.g., including one or more alkylene carbonates. An anode layer 225 is disposed adjacent the second electrolyte layer 210′ of the electrode-electrolyte composite 220. The anode layer 225 can include a lithium layer 230 coated onto a copper layer 235. A metal layer 240 can be disposed adjacent the electrode layer 205 of the electrode-electrolyte composite 220. The metal layer 240 can include an aluminum layer, where the metal layer 240 can therefore function as an aluminum current collector.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a solid-state electrode and electrolyte, comprising:
forming an electrode layer using an electrode composition, the electrode composition including a cathode active material, a lithiated ionomer, and an electrically conductive additive;
applying an electrolyte composition directly to the electrode layer to form a first electrolyte layer, the electrolyte composition including a lithiated perfluorosulfonic acid and a first solvent;
applying a reinforcement layer to the first electrolyte layer; and
applying the electrolyte composition to the reinforcement layer to form a second electrolyte layer, where the electrode layer, the first electrolyte layer, the reinforcement layer, and the second electrolyte layer form an electrode-electrolyte composite.

2. The method of claim 1, wherein the cathode active material includes one of a metal oxide and a metal phosphate.

3. The method of claim 2, wherein the cathode active material includes the metal oxide and the metal oxide includes a member selected from a group consisting of cobalt oxide, iron oxide, manganese oxide, and nickel oxide.

4. The method of claim 2, wherein cathode active material includes the metal phosphate and the metal phosphate includes a member selected from a group consisting of cobalt phosphate, iron phosphate, manganese phosphate, and nickel phosphate.

5. The method of claim 1, wherein the electrically conductive additive includes a member selected from a group consisting of carbon, carbon black, carbon microfibers, carbon nanofibers, carbon nanotubes, graphite nanofibers, and graphene.

6. The method of claim 1, wherein the electrode composition has a ratio of (the cathode active material):(the lithiated ionomer):(the electrically conductive additive) of (60-85):(10-20):(5-20).

7. The method of claim 1, wherein the electrode composition is processed to form a predetermined particle size prior to forming the electrode layer using the electrode composition.

8. The method of claim 7, wherein the predetermined particle size is from 10 nanometers to less than 1 micrometer.

9. The method of claim 1, wherein a solvent of the electrolyte composition includes a member selected from a group consisting of: methanol, ethanol, n-propanol, isopropanol, N-methyl-2-pyrrolidone (NMP), water, and combinations thereof.

10. The method of claim 1, wherein the electrolyte composition further includes a ceramic oxide.

11. The method of claim 1, wherein applying the electrolyte composition directly to the electrode layer to form the first electrolyte layer includes using one of a doctor blade, a micro gravure roller, and a slot die.

12. The method of claim 1, wherein the first electrolyte layer formed by applying the electrolyte composition directly to the electrode layer has a thickness from 2 micrometers to 30 micrometers.

13. The method of claim 1, wherein applying the reinforcement layer to the first electrolyte layer includes laminating the reinforcement layer to the first electrolyte layer.

14. The method of claim 1, further comprising swelling the electrode-electrolyte composite using a second solvent.

15. The method of claim 14, wherein the second solvent includes a member selected from a group consisting of: propylene carbonate, ethylene carbonate, and combinations thereof.

16. The method of claim 1, further comprising disposing an anode layer adjacent the second electrolyte layer of the electrode-electrolyte composite, the anode layer including a first metal layer.

17. The method of claim 16, wherein the anode layer further includes a second metal layer, the first metal layer including lithium and disposed adjacent the second electrolyte layer, the second metal layer including copper and disposed adjacent the first metal layer and opposite the second electrolyte layer.

18. A solid-state electrode and electrolyte made according to the method of claim 1.

19. A solid-state lithium-ion battery comprising a solid-state electrode and electrolyte made according to the method of claim 1.

20. A vehicle comprising a solid-state lithium-ion battery including a solid-state electrode and electrolyte made according to the method of claim 1.
